(19) United States
(12) Patent Application Publication
(10) Pub. No.: US 2005/0198660 A1
(43) Pub. Date: Sep. 8, 2005

(54) Optical pickup moving mechanism and disk drive using the same

(75) Inventors: Chung-ung Kim, Yongin-si (KR); Pil-je Cho, Yongin-si (KR); Young-sun Jung, Suwon-si (KR); Kyu-hyeong Lee, Suwon-si (KR); Sung-hun Lee, Suwon-si (KR); Young-woo Huh, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/038,028

(22) Filed: Jan. 21, 2005

(30) Foreign Application Priority Data
Mar. 4, 2004 (KR) 2004-14589

(51) Int. Cl. G11B 33/08; G11B 33/14; G11B 7/08; G11B 7/085; G11B 7/09

(52) U.S. Cl. 720/679; 720/651

(57) ABSTRACT

An optical pickup moving mechanism and a disk drive using the same are provided. The optical pickup moving mechanism includes a stepping motor, a lead screw rotatably connected to the stepping motor and moving an optical pickup in a radial direction of a disk, and a plurality of guide shafts installed in parallel with the lead screw and guiding the movement of the optical pickup in the radial direction of the disk, each of the guide shafts being provided with an insulator to insulate an electrical impact and vibration to prevent transmission of the electrical impact and the vibration to the optical pickup.

### CROSS-REFERENCE TO RELATED APPLICATIONS

This application claims the priority of Korean Patent Application No. 2004-14589, filed on Mar. 4, 2004, in the Korean Intellectual Property Office, the disclosure of which is incorporated herein by reference in its entirety.

### BACKGROUND OF THE INVENTION

1. Field of the Invention

The present invention relates to a disk drive, and more particularly to an optical pickup moving mechanism that can linearly move an optical pickup in a radial direction of a disk.

2. Description of the Related Art

Generally, a disk drive is a device that writes and reads information to and from a disk. For this, the disk drive includes an optical pickup moving mechanism to move an optical pickup in a radial direction of the disk.

FIG. 1 is a rear view that illustrates an example of a conventional sub-chassis assembly. Referring to FIG. 1, a sub-chassis assembly 100 includes a sub-chassis 101, a turntable 111 driven by a spindle motor 110 and rotating an optical disk 103 concentrically mounted thereon, an optical pickup 120 that linearly moves in a radial direction of the optical disk 103 to write and read information to and from the optical disk 103, and an optical pickup moving mechanism that linearly moves the optical pickup 120 in a radial direction of the optical disk 103.

The optical pickup moving mechanism includes a pair of guide shafts 141 and 142 installed in parallel with each other at the sub-chassis 101 to be separated from each other by a predetermined distance and guiding the linear motion of the optical pickup 120 in a radial direction of the optical disk 103, a lead screw 151 installed in parallel with the guide shafts 141 and 142 and having a threaded outer surface 152, a stepping motor 150 for rotating the lead screw 151, and a slider 160 that connects the optical pickup 120 and the lead screw 151 to convert the rotary force of the lead screw 151 to the linear motion so that the optical pickup 120 moves linearly in a radial direction of the optical disk 103.

The stepping motor 150, the spindle motor 110, and the guide shafts 141 and 142 are installed at the sub-chassis 101. The optical pickup 120 is slidingly installed at the guide shafts 141 and 142. Since the stepping motor 150, the spindle motor 110, the guide shafts 141 and 142, and the sub-chassis 101 are made of a conductive material, a vibration produced during rotation of the stepping motor 150 and the spindle motor 110 may cause malfunction of the optical pickup 120.

In addition, a leakage current from the stepping motor 150 and the spindle motor 110 may be transmitted to the optical pickup 120 via the sub-chassis 101 and the guide shafts 141 and 142, which adversely affects the optical pickup 120.

### SUMMARY OF THE INVENTION

Accordingly, it is an aspect of the present invention to overcome the above and/or other disadvantages of the conventional apparatus.

Additional aspects and/or advantages of the invention will be set forth in part in the description which follows and, in part, will be obvious from the description, or may be learned by practice of the invention.

The foregoing and/or other aspects are achieved by providing an optical pickup moving mechanism including guide shafts provided with an insulator that can prevent the transmission of a noise or a leakage current from a spindle motor and a stepping motor to an optical pickup.

The foregoing and/or other aspects are also achieved by providing an optical pickup moving mechanism to move an optical pickup which operates on a disk including: a stepping motor; a lead screw rotatably connected to the stepping motor and moving the optical pickup in a radial direction of the disk; and a plurality of guide shafts installed in parallel with the lead screw and guiding the movement of the optical pickup in a radial direction of the disk, each of the guide shafts including an insulator to insulate an electrical impact and vibration received from the stepping motor to prevent transmission of the electrical impact and the vibration to the optical pickup.

The insulator may be of a cap shape to be inserted into both ends of each of the guide shafts.

### BRIEF DESCRIPTION OF THE DRAWINGS

The above and/or other features and/or advantages of the present invention will become more apparent by describing in detail exemplary embodiments thereof with reference to the attached drawings in which:

FIG. 1 is a rear view that illustrates an example of a conventional sub-chassis assembly;

FIG. 2 is a schematic perspective view of a disk drive including an optical pickup moving mechanism for use with the embodiments of the invention;

FIG. 3 is a perspective view of guide shafts according to a first embodiment of the present invention;

FIG. 4 is a perspective view that illustrates the fixation of the guide shafts of FIG. 3 to a base chassis;

FIG. 5 is a side sectional view that illustrates the fixation of the guide shafts of FIG. 3 to the base chassis;

FIG. 6 is a cross-sectional view of guide shafts according to a second embodiment of the present invention; and

FIG. 7 is a cross-sectional view of guide shafts according to a third embodiment of the present invention.

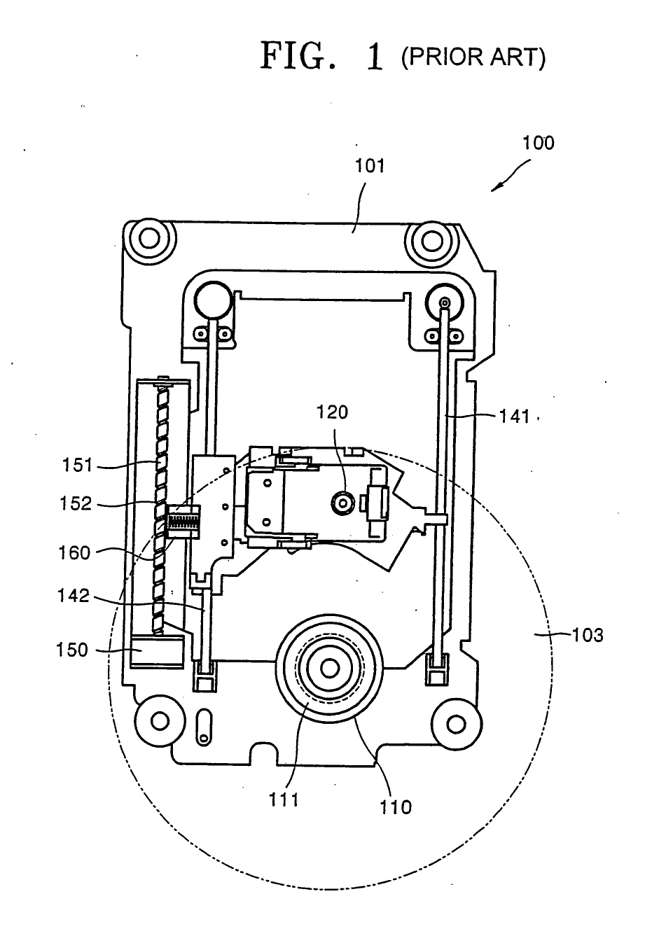

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

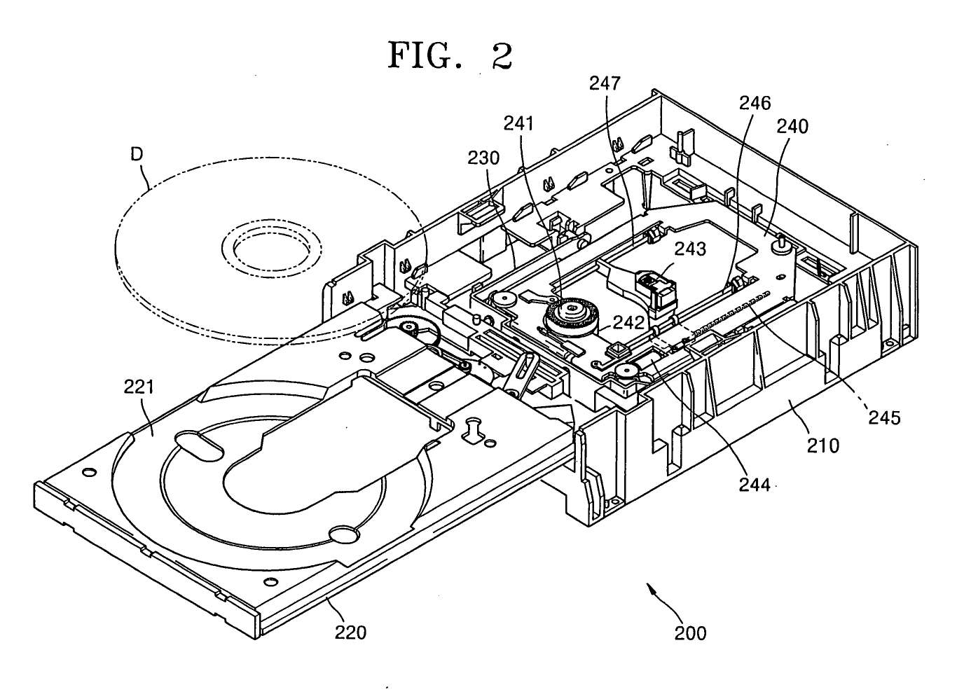

Referring to FIG. 2, a disk drive 200 includes a main frame 210, a tray 220 removably installed at the main frame 210 and having a receiving portion 221 to receive a disk D, a base chassis 240 supported by a sub frame 230 installed at the main frame 210 to move upward and downward, and an optical pickup moving mechanism that linearly moves an optical pickup 243 in a radial direction of the disk D.

The base chassis 240 is provided with a turntable 241 on which the disk D received in the tray 220 is loaded, a spindle motor 242 installed coaxially with the turntable 241 to rotate the turntable 241, and the optical pickup 243 that linearly moves in a radial direction of the disk D to write and read information to and from the disk D.

The optical pickup moving mechanism includes a stepping motor 244, a lead screw 245 connected to the stepping motor 244 and linearly moving the optical pickup 243 in a radial direction of the disk D, and a plurality of guide shafts 246 and 247 installed at the base chassis 240 to be parallel with the lead screw 245 and to guide the movement of the optical pickup 243 in a radial direction of the disk D. Each of the guide shafts 246 and 247 is provided with an insulator (described below) to insulate an electrical impact and vibration to prevent the transmission of the electrical impact and vibration to the optical pickup 243.

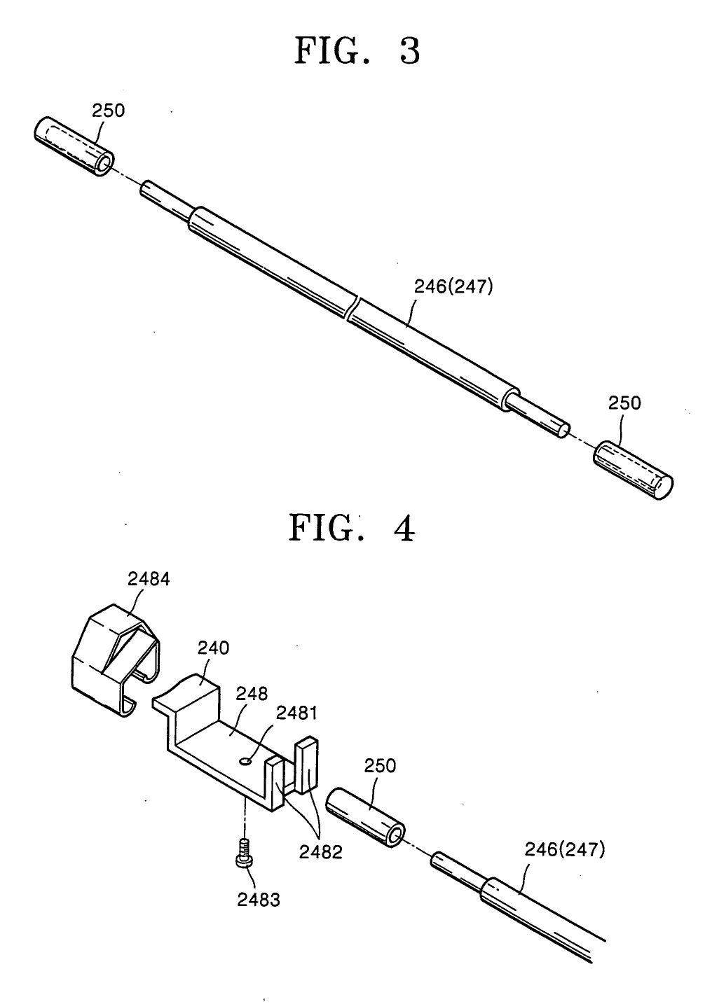

Referring to FIG. 3, an insulator 250 according to a first embodiment of the present invention has a cap shape to be inserted onto both ends of each of the guide shafts 246 and 247.

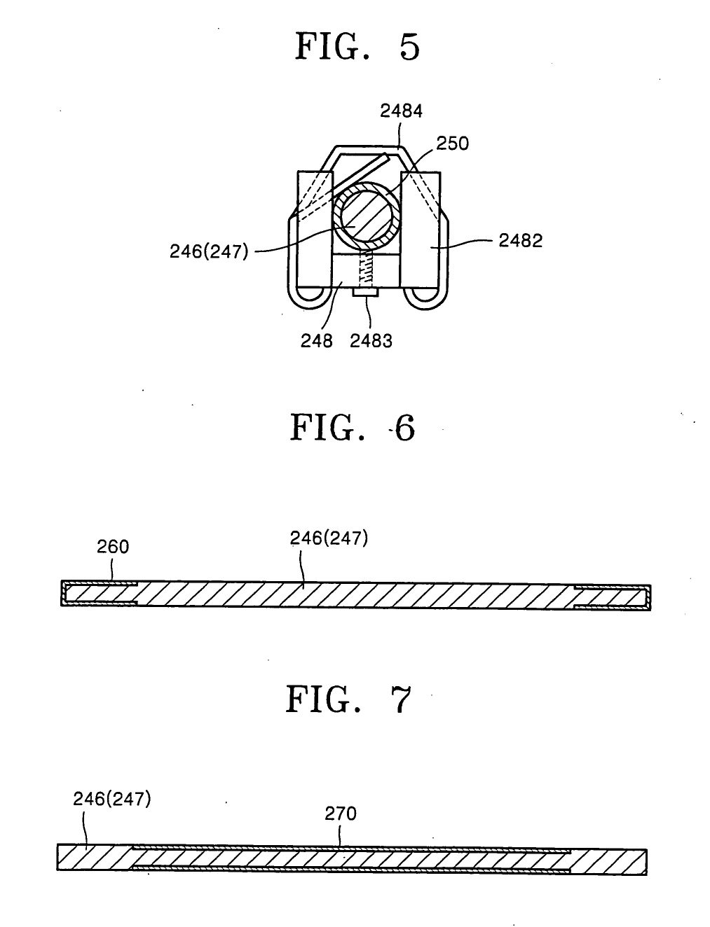

Referring to FIGS. 4 and 5, both ends of each of the guide shafts 246 and 247 are supported by a support member 248 extended from the base chassis 240. The support member 248 includes a plurality of projections 2482 spaced apart from each other to insert the insulator 250 into both ends thereof and a through-hole 2481 intended for insertion of a screw 2483. The insulator 250 is fixedly inserted in the support member 248 by downward pressing of an elastic member 2484 surrounding the insulator 250 together with the support member 248 and upward pressing of the screw 2483 inserted in the through-hole 2481.

The insulator 250 is made of an insulating material able to prevent a current flow and absorb an external impact or vibration.

Therefore, even when the base chassis 240, the elastic member 2484, and the screw 2483 are conductors, the insulator 250 can prevent a current flow to the guide shafts 246 and 247. Consequently, a current flow to the optical pickup 243 slidingly installed at the guide shafts 246 and 247 can be prevented.

Referring to FIG. 6, an insulator 260 according to a second embodiment of the present invention is formed by molding or coating on both ends of each of the guide shafts 246 and 247.

Therefore, as in the first embodiment as shown in FIG. 5, when both ends of each of the guide shafts 246 and 247 are supported by the support member 248, the insulator 260 insulates the guide shafts 246 and 247 from the support member 248, the elastic member 2484, and the screw 2483 to prevent a current flow to the optical pickup 243.

Referring to FIG. 7, an insulator 270 according to a third embodiment of the present invention is formed by molding to cover an outer surface of each of the guide shafts 246 and 247. The insulator 270 may also be formed by coating an outer surface of each of the guide shafts 246 and 247. The insulator 270 is formed on the axial outer surface of each of the guide shafts 246 and 247 corresponding to a distance for linear motion of the optical pickup 243.

As in the first and second embodiments shown in FIGS. 5 and 6, respectively, both ends of each of the guide shafts 246 and 247 are supported by the support member 248 when the third embodiment of the insulator is applied. The optical pickup 243 moves linearly along the guide shafts 246 and 247 in a state of contact with the insulator 270.

Therefore, even when current is transmitted to the guide shafts 246 and 247 from the spindle motor 242 and the stepping motor 244 via the support member 248, the insulator 270 prevents a current flow to the optical pickup 243.

As described above, an optical pickup moving mechanism of the present invention includes an insulator on both ends or an outer surface of each of guide shafts so that current or vibration from a base chassis cannot be transmitted to an optical pickup. Therefore, the reliability of the optical pickup can be enhanced.

Although a few embodiments of the present invention have been shown and described, it would be appreciated by those skilled in the art that changes may be made in these embodiments without departing from the principles and spirit of the invention, the scope of which is defined in the claims and their equivalents.

1. An optical pickup moving mechanism to move an optical pickup which operates on a disk comprising:
a stepping motor;
a lead screw rotatably connected to the stepping motor and moving the optical pickup in a radial direction of the disk; and
a plurality of guide shafts installed in parallel with the lead screw and to guide the movement of the optical pickup in the radial direction of the disk, each of the guide shafts comprising an insulator to insulate an electrical impact and vibration received from the stepping motor to prevent transmission of the electrical impact and the vibration to the optical pickup.

2. The optical pickup moving mechanism of claim 1, wherein each of the insulators comprises a plurality of cap shaped elements to be respectively inserted onto both opposite ends of the respective guide shaft.

3. The optical pickup moving mechanism of claim 1, wherein each of the insulators is formed by coating opposite ends of the respective guide shaft.

4. The optical pickup moving mechanism of claim 1, wherein each of the insulators is formed by molding to cover an outer surface of the respective guide shaft.

5. The optical pickup moving mechanism of claim 4, wherein each of the insulators is formed on an axial outer surface of the respective guide shaft corresponding to a distance of movement of the optical pickup in the radial direction of the disk.

6. A disk drive to operate on a disk, comprising:
a housing;
a tray removably installed at the housing and holding the disk; and
a base frame comprising:
a turntable on which the disk is loaded,
a spindle motor to rotate the turntable,
an optical pickup to read and write information from or to the disk, and
an optical pickup moving mechanism to move the optical pickup in a radial direction of the disk, comprising:
a stepping motor,
a lead screw rotatably connected to the stepping motor and to moving move the optical pickup in the radial direction of the disk, and
a plurality of guide shafts installed in parallel with the lead screw and to guide the movement of the optical pickup in the radial direction of the disk, each of the guide shafts comprising an insulator to insulate an electrical impact and vibration received from the stepping motor to prevent transmission of the electrical impact and the vibration to the optical pickup.

7. The disk drive of claim 6, wherein each of the insulators comprises a plurality of cap shaped elements to be respectively inserted onto opposite ends of the respective guide shaft.

8. The disk drive of claim 6, wherein each of the insulators is formed by coating opposite ends of the respective guide shaft.

9. The disk drive of claim 6, wherein each of the insulators is formed by molding to cover an outer surface of the respective guide shaft.

10. The disk drive of claim 9, wherein each of the insulators is formed on an axial outer surface of the respective guide shaft corresponding to a distance of movement of the optical pickup in the radial direction of the disk.

11. The optical pickup moving mechanism of claim 1, further comprising:
a base; and
a plurality of support members extending from the base to respectively support the guide shafts.

12. The optical pickup moving mechanism of claim 11, wherein the support members each comprise:
a main body;
a plurality of projections extending from the main body and spaced from each other to receive the respective insulator therebetween;
a through hole formed in the main body; and
a screw passing through the through hole to attach the support member to the base.

13. An apparatus to move an optical pickup relative to a disk comprising:
a stepping motor; and
a guide shaft to guide the optical pickup and prevent a transfer of an electrical impact or vibration by the stepping motor to the optical pickup.
